(19) United States
(12) Patent Application Publication
(10) Pub. No.: US 2007/0019501 A1
(43) Pub. Date: Jan. 25, 2007

(54) Fixture to treat scalp hair with steam

(76) Inventor: Stefan Kiessl, Bad Karlshafen (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/376,404

(22) Filed: Mar. 15, 2006

(30) Foreign Application Priority Data
Mar. 15, 2005 (DE) 102005012246.9

(51) Int. Cl. B01F 15/06

(52) U.S. Cl. 366/144

(57) ABSTRACT

A fixture (1) to treat scalp hair using water vapor (2) with a steam generator (3), wherein the water vapor (2) flows into an existing mixing chamber (5) consisting primarily of plastic (4), and cool, dry ambient air (6) is added, with said air being fed by a fan (7), whereby a mixture of ambient air (6) and water vapor (2) results, wherein the steam/air mixture (8) flows out of the mixing chamber (5) into a crescent-shaped steam nozzle (9) having a multitude of exit openings (10), from which the water vapor (2) exits and is thoroughly distributed, wherein the steam nozzle (9) is arranged within a Plexiglas dome (11). In order to create an electric field (12) using a high voltage generator (13), a pointy electrode (14) extends into the mixing chamber (5), and a counter electrode (16) is arranged on the opposing exterior side (15) of the mixing chamber (5), whereby an ionized steam/air mixture (32) can be optionally created (FIG. 1).

### BACKGROUND OF THE INVENTATION

The present invention relates to a fixture of the generic type indicated in the preamble of Claim 1.

Such fixtures are known, for example, from DE10324117A1 and DE10326979A1 of the applicant. These fixtures enable the water vapor treatment of scalp hair that has been treated with an agent, wherein an even distribution of the water vapour throughout the hair is ensured during treatment. A removable, fillable water kettle is provided for supplying the water. Furthermore, there is a control for treatment time, steam intensity, and temperature.

### BRIEF SUMMARY OF THE INVENTION

The object of the invention is to obtain a generically equivalent fixture to enable, through simple measures, the steam quality to be influenced.

The task is achieved in accordance with the features of the distinguishing component of claim 1. The ionized water vapor that is created to treat scalp hair in this process has a positive effect on hair previously treated with an agent (for example conditioning, perming, coloring, or styling agent). Additional advantageous developments/embodiments of the invention result from the sub-claims.

### BRIEF DESCRIPTION OF THE DRAWINGS

The invention is described in more detail by means of an exemplary embodiment.

The following is shown:

FIG. 1 shows a schematic representation of a fixture;

FIG. 2 shows a sectional side view of a complete fixture;

FIG. 3 shows an enlarged side view of an electrode;

FIG. 4 shows a perspective view of the electrode according to FIG. 3;

FIG. 5 shows an enlarged top view of a development of a counter electrode;

FIG. 6 shows a side view of the counter electrode according to FIG. 5;

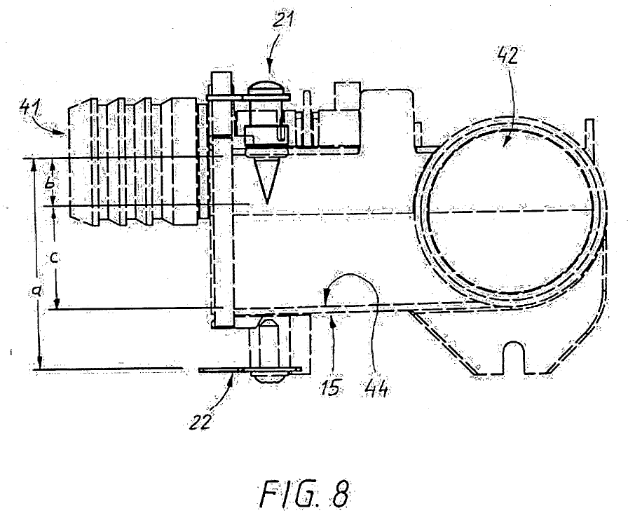

FIG. 7 shows a schematic representation of a mixing chamber;

FIGS. 8-10 shows various views of the mixing chamber according to FIG. 7, wherein one section (VIII-VIII) is highlighted in FIG. 8 according to FIG. 10;

FIG. 11 shows a perspective view of the mixing chamber according to FIGS. 7 through 10; and

FIG. 12 shows a principal representation of the mixing chamber.

### DETAILED DESCRIPTION OF THE INVENTATION

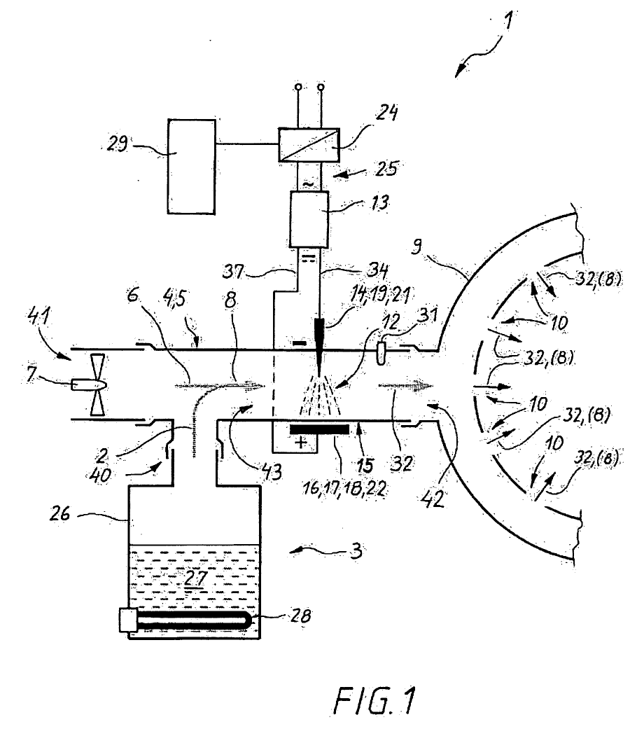

FIG. 1 schematically illustrates a fixture 1 to treat scalp hair using water vapor 2 with a steam generator 3, wherein the water vapor 2 flows into an existing mixing chamber 5 consisting primarily of plastic 4, and cool, dry ambient air 6 is added, with said air being fed by a fan 7, whereby a mixture of ambient air 6 and water vapor 2 results, wherein the steam/air mixture 8 flows out of the mixing chamber 5 into a crescent-shaped steam nozzle 9 having a multitude of exit openings 10, from which the water vapor 2 and/or the steam/air mixture 8 exits and is thoroughly distributed. The steam nozzle 9 is arranged inside a Plexiglas dome 11. In order to create an electric field 12 using a high voltage generator 13, a pointy electrode 14 extends into the mixing chamber 5, and a counter electrode 16 is arranged on the opposing exterior side 15 of the mixing chamber 5, whereby an ionized steam/air mixture 32 can be optionally created.

The steam generator 3 consists of a kettle 26 filled with water 27. In order to create water vapor 2, the kettle 26 has an electric heating unit 28.

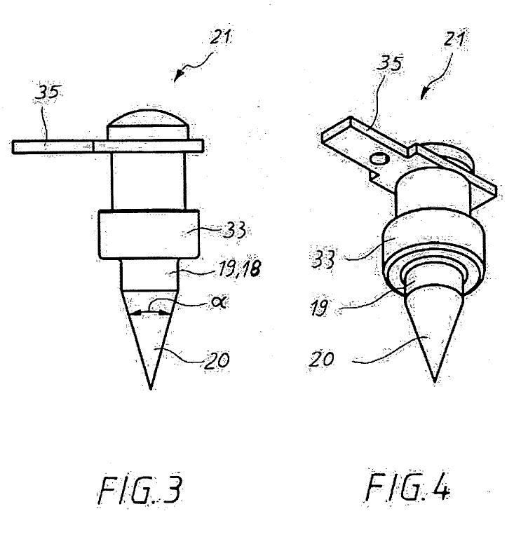

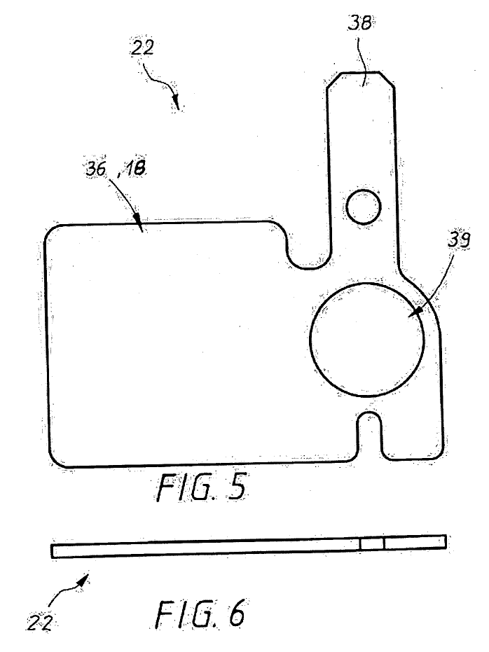

The electrode 14 is designed like a pin 19 with a point 20 and preferably consists of stainless steel 18. The tip 20 has an angle (alpha) of approximately 32 degrees (FIGS. 3 and 4). The electrode 14 is embodied as a cathode 21 and the counter electrode 16 is embodied as an anode 22. The counter electrode 16 consists of a small metal plate 17, preferably made of stainless steel 18.

There is DC voltage (V) of approximately 5 kV between the electrode 14 and the counter electrode 16. The DC voltage (V) is optionally pulsed by a device 24. The pulsing 25 of the DC voltage (V) consists of a 60 s switch-on and a 15 s switch-off, wherein the device 24 is program-controlled by a microprocessor 29.

Water 27 is transformed into steam in a kettle 26 using an electric heating unit 28. The kettle 26 can be removed from the fixture 1 and filled.

The saturated, hot water vapor 2 flows into the mixing chamber 5. At that point, cool, dry ambient air 6 is added; the ambient air is fed by a fan 7. This results in a mixture of ambient air 6 and water vapor 2, thus resulting in a reduction in the temperature of the water vapor 2. This is necessary to ensure that the person being treated is not exposed to an excessively high steam temperature during the steam treatment.

The steam/air mixture 8 then flows from the mixing chamber 5 into a crescent-shaped steam nozzle 9 having a multitude of exit openings 10. The steam/air mixture 8 exits from the steam nozzle 9 and is thoroughly distributed.

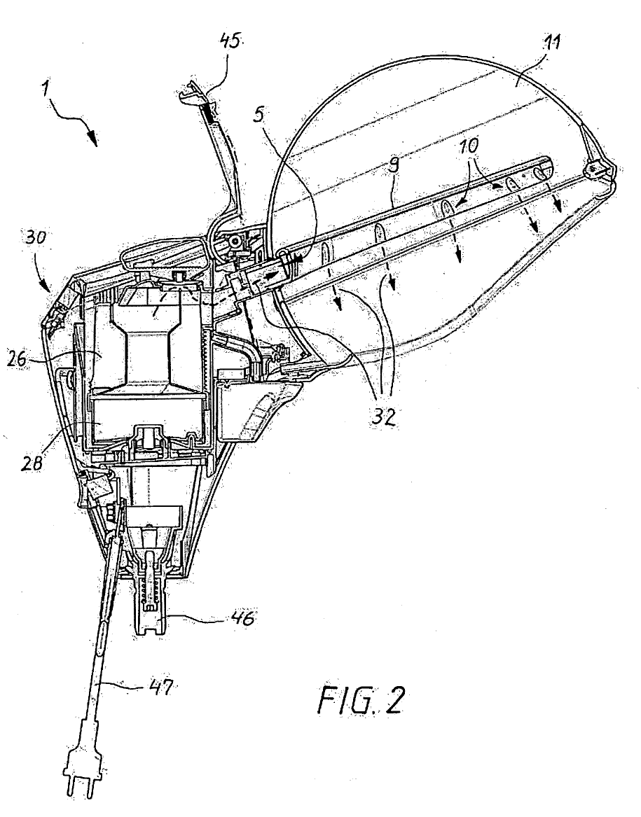

FIG. 2 shows the complete fixture 1 with an open lid 45, which would otherwise close the kettle 26. The steam nozzle 9 is arranged in a Plexiglas dome 11, which is placed about a person during the treatment. The treatment time and steam temperature can be set using a control panel 30 on the fixture 1. The steam temperature is controlled by heating power from the electric heating unit 28. The mixing chamber 5 contains a corresponding temperature sensor 31, which then corresponds to the microprocessor 29. A connecting journal 46 is arranged on a tripod stand (not shown) to provide support for the fixture 1. The fixture 1 is supplied with current via the mains supply 47.

Additional Description of the Steam Ionization Device:

The mixing chamber 5 contains a thin metal tip 19 at a suitable site to which negative high voltage is routed, wherein the metal tip 19 is inserted into the mixing chamber 5 from the outside. A contact 38 located outside the mixing chamber 5 is used for electrical contacting. There is an interior component in the flow of steam. The counter electrode 16 (small thin metal plate 17 made of stainless steel 18) is arranged on the outside 15 of the mixing chamber 5, on the opposing side, as an electrically positive electrode (anode 22).

The arrangement of the counter electrode 16 outside of the steam area 43 advantageously prevents a conducting connection from resulting between the electrodes 14, 16 in the damp atmosphere within the mixing chamber 5, thus preventing the voltage (V) from breaking down.

A stationary, electric field 12 forms between the electrodes 14, 16, wherein the field strength is relatively high in the area of the tip 20. Air molecules of the air 6 streaming by are ionized in this zone. The ionized air molecules subsequently charge the resulting steam droplets, which flow, as an ionized steam/air mixture 32, into the steam nozzle 9 and are made available for steam-treating scalp hair via the exit openings 10.

The negative voltage is created by a high voltage generator 13.

It generates negative DC voltage of approximately −5 kV from mains alternating voltage. A device 24 switches the mains voltage to the high voltage generator 13. The device 24 is controlled by an existing microprocessor 29 in the fixture 1. In this manner, the high voltage can be activated using program control.

If the steam ionization is activated, the high voltage (V) is controlled in a pulse operation. The continuous pulsing consists of 60 s high voltage (V) on and 15 s high voltage (V) off. The switch-off action limits the number of charge carriers, whereby, within the 15 s, a portion of the charges can relax, e.g. via the steam 8 flowing out. The preset pulse ratio of 60 s/15 s can be changed as needed. The user can switch the ionization ON or OFF on the fixture 1.

Due to the invention, it is now possible, through simple measures, to modify existing fixtures 1 with the option of steam ionization. The water vapor 2 can be ionized continuously or optionally in pulses 25 during operation; this is contrary to fixtures from the prior art that function without ionization of the steam, or fixtures with which either water vapor or dry, ionized air is alternatingly expelled.

FIGS. 3 and 4 show the cathode 21. The tip 20 which is located in the steam 2 has an angle alpha of approximately 32 degrees and consists preferably of stainless steel. A ring 33 is provided for mounting and sealing the cathode 21 to the mixing chamber 5. A contact 35 is provided for contacting with a high-voltage cable 34 (FIG. 1).

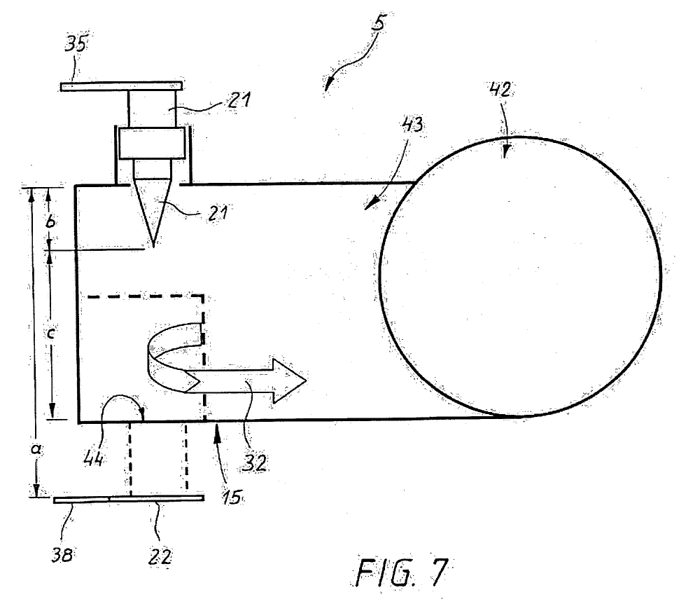

FIG. 5 shows the anode 22, which preferably consists of stainless steel and an electrode surface 36 of approximately 10×0.39 in (10 mm).

A contact 38 is provided for contacting with an additional cable 37 (FIG. 1). An eye 39 is used to mount the mixing chamber 5.

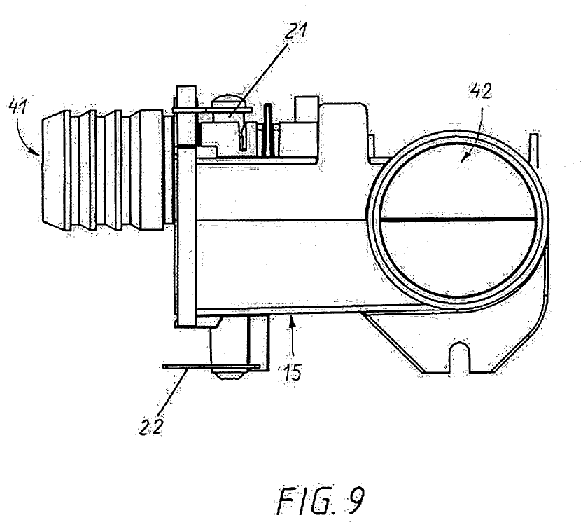

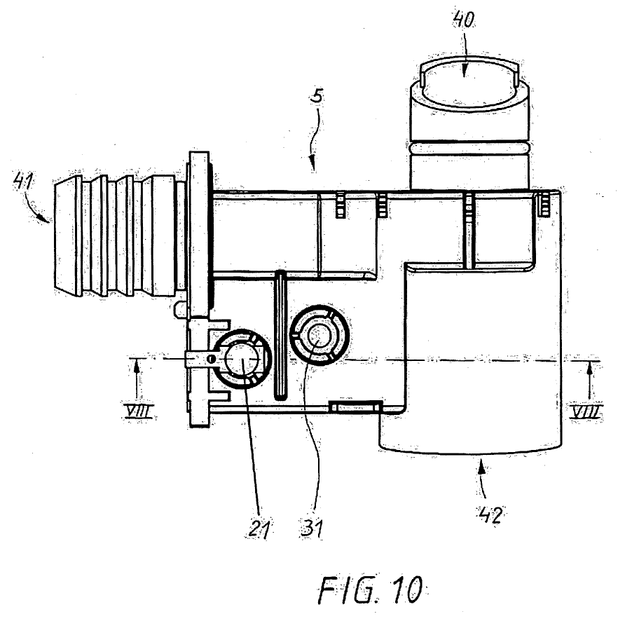

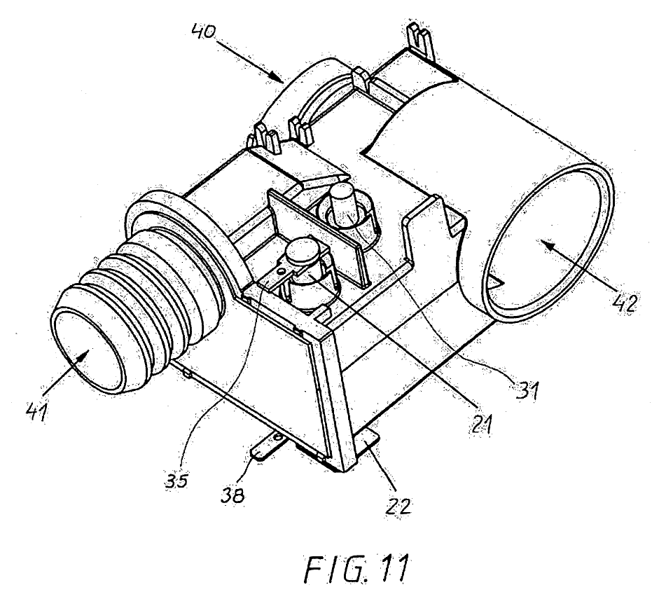

FIGS. 7 through 11 show various views of the mixing chamber 5, which preferably consists of an injection molded part made of polyethylene. The mixing chamber 5 has a steam inlet 40, an ambient air inlet 41, and an outlet 42 for the steam/air mixture 8, 32. The distance a between the tip 20 of the cathode 21 and the anode 22 is approximately 1.02 in (26 mm), wherein the cathode 21 extends into the steam area 43 with a depth b of approximately 0.26 in (6.5 mm). The distance c between the tip 20 of the cathode 21 and the interior wall of the mixing chamber 44 (path with high field density) is approximately 0.61 in (15.5 mm).

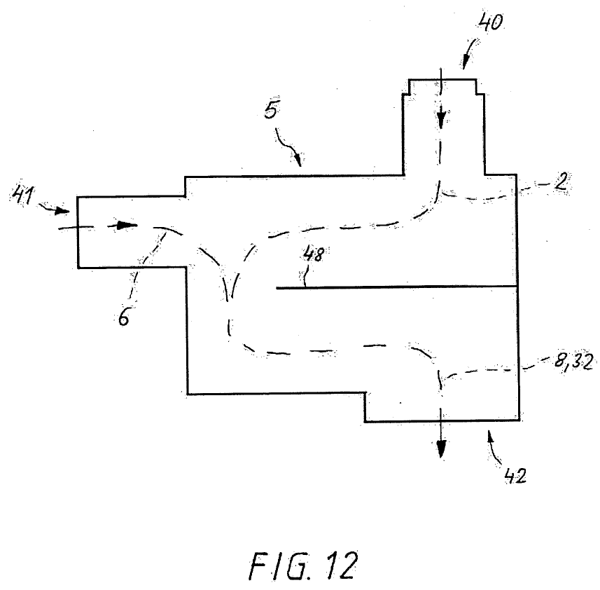

FIG. 12 shows the mixing chamber 5 in a principle representation, wherein, in this case, the pattern of ambient air 6, water vapor 3, and the steam/air mixture 8 is shown in more detail. A guide wall 48 is provided to combine ambient air 6 and water vapor 3.

### REFERENCE LIST

1 Fixture
2 Water vapor
3 Steam generator
4 Plastic
5 Mixing chamber
6 Ambient air
7 Fan
8 Steam/air mixture
9 Steam nozzle
10 Exit openings
11 Plexiglas dome
12 Electric field
13 High voltage generator
14 Electrode
15 Exterior side/mixing chamber 5
16 Counter electrode
17 Metal plates
18 Stainless steel
19 Pin
20 Tip
21 Cathode
22 Anode
23 −
24 Device
25 Pulsing
26 Water kettle
27 Water
28 Electrical heating unit
29 Microprocessor
30 Control panel
31 Temperature sensor
32 Ionized steam/air mixture
33 Ring
34 First high-voltage cable
35 Contact
36 Electrode surface
37 Second high-voltage cable
38 Contact
39 Eye
40 Steam inlet
41 Air inlet
42 Steam/air mixture outlet
43 Steam area
44 Interior wall of the mixing chamber
45 Lid
46 Connecting journal
47 Mains line
48 Guide wall
a Distance
b Depth
c Distance
V DC voltage
Alpha Angle/tip 20

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fixture (1) to treat scalp hair using water vapor (2) comprising a steam generator (3), wherein the water vapor (2) flows into an existing mixing chamber (5) consisting primarily of plastic (4), and cool, dry ambient air (6) is added, with said air being fed by a fan (7), whereby a mixture of ambient air (6) and water vapor (2) results, wherein the steam/air mixture (8) flows out of the mixing chamber (5) into a crescent-shaped steam nozzle (9) having a multitude of exit openings (10), from which the water vapor (2) exits and is thoroughly distributed and wherein the steam nozzle (9) is arranged within a Plexiglas dome (11), wherein, in order to create an electric field (12) using a high voltage generator (13), a pointy electrode (14) extends into the mixing chamber (5), and a counter electrode (16) is arranged on the opposing exterior side (15) of the mixing chamber (5).

2. A fixture according to claim 1, wherein the counter electrode (16) comprises a small metal plate (17).

3. A fixture according to claim 1, wherein the pointy electrode (14) and the counter electrode (16) are comprised of stainless steel (18).

4. A fixture according to claim 1, wherein the pointy electrode (14) is designed as a type of pin (19) with a tip (20).

5. A fixture according to claim 4, wherein the tip (20) has an angle (alpha) of approximately 32 degrees.

6. A fixture according to claim 1, wherein the pointy electrode (14) is embodied as a cathode (21) and the counter electrode (16) is embodied as an anode (22).

7. A fixture according to claim 1, wherein there is DC voltage (V) of approximately 5 kV between the pointy electrode (14) and the counter electrode (16).

8. A fixture according to claim 7, wherein the DC voltage (V) is pulsed by a device (24).

9. A fixture according to claim 8, wherein the pulsing (25) of the DC voltage (V) consists of a 60 s switch-on and a 15 s switch-off.
